(19) United States
(12) Patent Application Publication
(10) Pub. No.: US 2015/0190870 A1
(43) Pub. Date: Jul. 9, 2015

(54) Colli-BeckSS

(71) Applicant: Jack Eakle Colliflower, Newberg, OR (US)

(72) Inventor: Jack Eakle Colliflower, Newberg, OR (US)

(21) Appl. No.: 14/151,275

(22) Filed: Jan. 9, 2014

(51) Int. Cl. B23D 47/02

(52) U.S. Cl. CPC B23D 47/025

(57) ABSTRACT

The Colli-BeckSS is a zero-clearance throat plate designed specifically for SawStop table saws. The plate has many new and unique features, including a replaceable-insert design for continual zero-clearance with all blade kerfs, anti-pinch features for the replaceable insert, anti-flip-back features for the plate, and surface leveling features. This plate is designed to outperform any previously made throat plates made for the SawStop table saw.

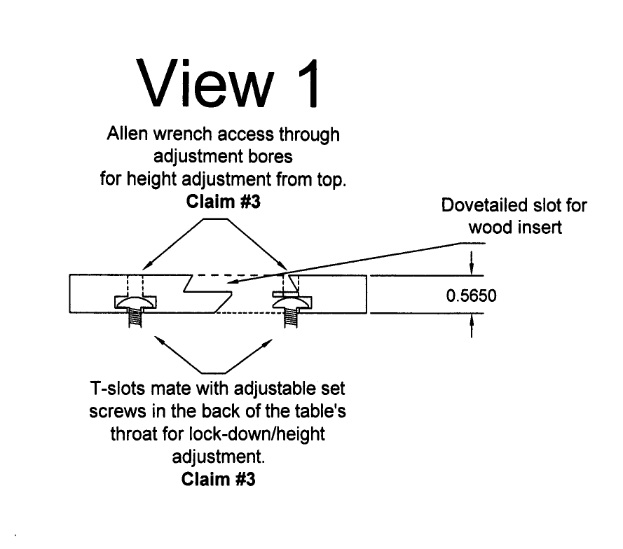

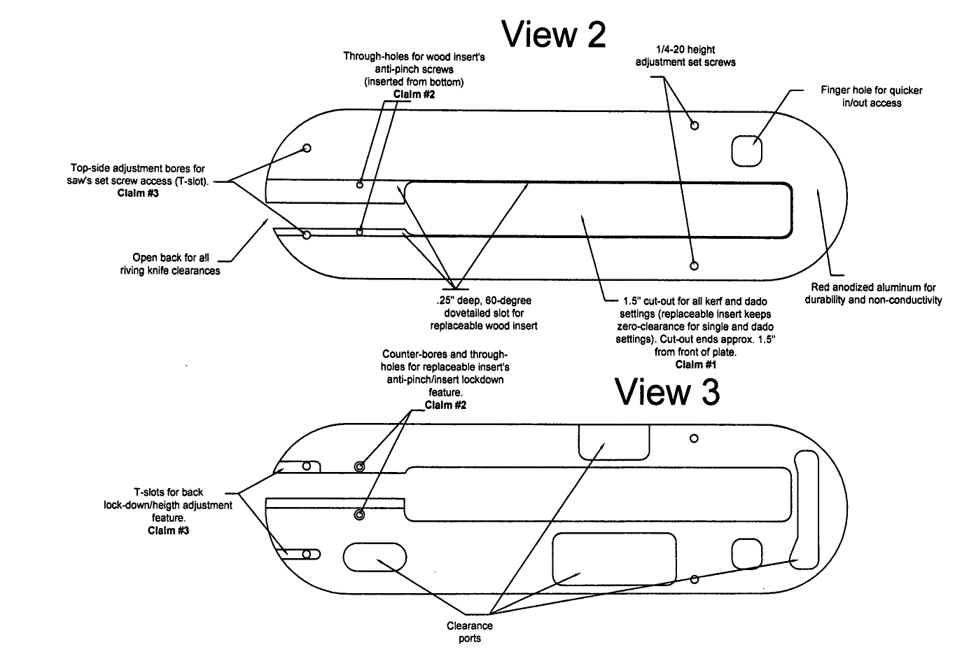

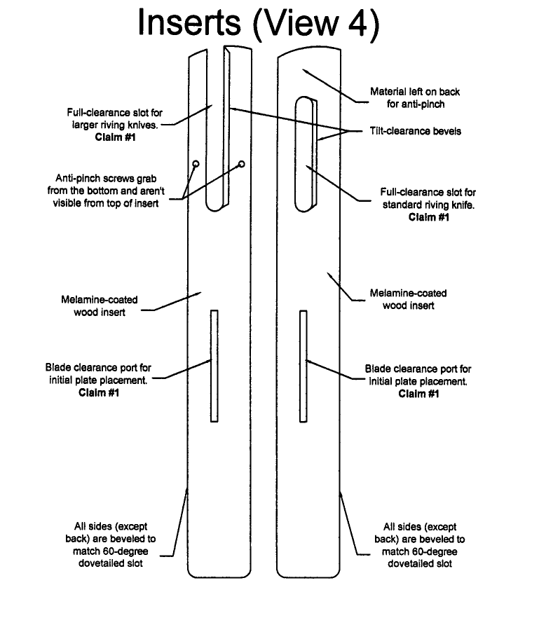

### CROSS-REFERENCE TO RELATED APPLICATIONS

(Earlier Provisional) Application No. 61/751,477

### BACKGROUND OF INVENTION

The Colli-BeckSS was designed to better the throat plate which is provided with the SawStop table saw upon purchase. The provided throat plate's two main issues which needed bettering were the limited zero-clearance (See below for a definition of zero-clearance.) and the lockdown mechanism which holds the plate down at the back of the throat of the saw. The provided throat plate is regarded as zero-clearance, but it does not provide the perpetual, replaceable zero-clearance that is needed to make the plate satisfactory.

Once the provided plate's zero-clearance slot is cut, the saw blade's vibration—within as little as an hour's worth of use—will make the slot wider than the kerf of the blade, resulting in no more zero-clearance. Or, once a larger-kerf saw blade is used with the plate, the zero-clearance slot is cut for that width, which then leaves a gap between the “zero-clearance slot” and any blade used which has a thinner kerf. Dado blades/settings completely eliminate any previously held zero-clearance on the stock plate. I realized that the provided plate needed improvement and decided to make a zero-clearance plate which greatly outperforms it. Upon designing and making this product, I found three aspects of its design that are patentable.

### BRIEF DESCRIPTION OF THE INVENTION

The Colli-BeckSS is an aftermarket, anodized aluminum, zero-clearance table saw throat plate designed to fit all SawStop table saws. The Colli-BeckSS is designed to outperform the company-provided zero-clearance throat plate by supplying a throat plate which gives perpetual (replaceable) zero-clearance by means of a replaceable, slide-in and-out zero-clearance insert which has a unique lockdown/anti-pinch feature. This design also has a faster, safer way of securing the plate to the saw and adjusting its height.

### BRIEF DESCRIPTION OF SEVERAL VIEWS OF THE DRAWING

A drawing with four views is included in this patent submission. The drawing is of the Colli-BeckSS throat plate and its replaceable inserts.

View 1 is the view from the back of the plate if, while the plate is resting in the throat of the saw, it is seen from the operator's position in front of the saw. This view shows the T-slots which mate with the saw's adjustable set screws which are in the back of the saw's throat. The anti-flip back measure can be seen from this view, as well, since it can be observed that the bottom of the adjustable set screws are “housed” inside the T-slot, with no way of their coming out aside from the plate being purposefully slid out of the throat of the saw. View 1 also shows the adjustment bores which lead down from the top of the plate and to the T-slots, resulting in an access way to the T-slots and, therefore, to the saw's adjustable set screws. From this view can be seen the dovetailed slot into which the unique replaceable inserts slide.

View 2 shows the plate from the top. Patentable aspects of note in this view are the adjustment bores and the counter-bores/through-holes in which the anti-pinch are places in order to secure the replaceable insert. The dovetailed slot for the replaceable inserts can be viewed, as well.

View 3 shows the bottom of the plate. The bottom of the T-slots can be seen in this view, as well as the counter-bores and through-holes in which the anti-pinch screws are placed.

View 4 shows the unique replaceable inserts. This is a bottom view of the inserts. The full clearance (open-back) slot for the larger riving knives can be seen, as well as the full clearance slot (closed back) for the standard riving knife. The approximate placement for where the anti-pinch screws are screwed into the insert can be seen. Further, the blade clearance port for initial throat plate placement is shown. Bevels for full riving knife and blade clearance at all tilts can be seen, as well.

### DETAILED DESCRIPTION

A throat plate can be defined as an essential table saw accessory which sits in the throat of a table saw. The throat of a table saw is the opening on the table through which the saw blade is raised and in which the throat plate rests. The material to be cut on the saw slides on the throat plate and through the blade which is raised through the throat plate.

A zero-clearance throat plate can be defined as a throat plate which leaves little-to-no gap between the side of a raised blade and the remainder of the throat plate. The slot through which the blade is raised is called a zero-clearance slot and is obtained by having the rotating blade raised up through the throat plate in order to cut the slot. By this method, the zero-clearance slot is only as wide as the kerf of the blade. This zero-clearance slot results in many benefits, including more support of the work-piece, less wear on the saw, and a safer cut.

One of the unique features of the Colli-BeckSS throat plate is the slide-in/slide-out, 0.25″, replaceable insert with two options for riving knife compatibility. This feature allows for replaceable, reusable zero-clearance for all kerfs and dado settings.

The two unique replaceable, slide-in and slide-out inserts for the throat plate are specially made for riving knife and saw blade compatibility. The first style comes with a slot (approximately 0.375 inches wide) extending from the very back of the plate to approximately 5.0 inches into the plate. This slot is aligned with the saw blade and, therefore, aligned with the saw's riving knife. This slot is made so that the larger riving knives which are made for the SawStop saw (those used with the blade guard or dust collection systems) can have full clearance as they follow the blade in its upward and downward heights. The slot on this insert is also beveled on one side in order to allow full clearance for all saw blade and riving knife tilts at all extensions. This open-back slot design allows for quick in/out access of the throat plate when using the blade guard or dust collection riving knives.

The second style of replaceable insert with a riving knife slot is for use with the standard, smaller riving knife. This slot in this insert does not begin at the very back of the plate/insert: It begins approximately 1.0 inches from the back and extends to the same position as the previous insert—approximately 5.0 inches into the insert. This closed-back design allows full strength and rigidity. This insert has the beveled slot, as well, to account for full clearance of the riving knife and blade at all tilts and heights.

Both styles of inserts include a clearance port on the bottom in order to account for the blade's height in a “resting” (lowered) position. Without the slot, the insert would hit the top of the blade, not allowing the throat plate to sit flat before the zero-clearance slot is cut.

Both styles of inserts have a beveled edge which mates with the 60″ dovetailed slip of the throat plate. (See drawing for an in-depth explanation.) This allows for easily replaceable inserts to be slipped in and out of the throat plate. This dovetailed slip, which is cut into the throat plate, does not extend throughout the length of the plate: The slip stops approximately 1.5″ from the front of the plate in order for the plate to maintain strength and rigidity. That the replaceable insert extends only from the very back of the plate to a stopping point within the plate (and does not fully extend from one end to the other) is unique.

This replaceable insert design is accomplished by means of tapered router bits and various-sized table saw blades.

Another unique feature of the Colli-Beck plate is the T-slot lockdown and adjustment bore at the back of the plate. This T-slot in the plate is made so that the slots mates with the adjustable set screws which are in the back of the throat of the saw. (These screws which come with the saw have a mushroom, cap-screw-like head with an alien wrench hex on top for adjustment.) The T-slots are so that the plate can be slid into place, with the heads of the set screws slipped into the slots. When the screws are in the T-slots of the throat plate, an anti-flip back measure is employed, since the back of the plate cannot be flipped forward (toward the operator) by means of the saw blade accidentally hitting the plate. The set screws in the T-slots are then adjusted so that the back of the plate sits flush with the top of the table. These set screws are adjusted by means of the adjustment bore from above the plate.

The adjustment bores are through-holes from the top of the plate which lead to the T-slots, in which are the saw's set screws. With these adjustment bores, the set screws in the T-slots can be adjusted for height from the top of the plate while the throat plate is in the throat of the saw.

This T-slot and adjustment bore design is made by means of employing various-sized key seat cutters, endmills and drills to the throat plate upon manufacture in a CNC mill.

The last unique feature of the plate is the replaceable insert's anti-pinch, lockdown system. As mentioned previously, when using the replaceable insert compatible with the larger living knives (the insert which has an open back due to the slot beginning from the very back), once the full zero-clearance slot is cut by the saw's blade, the replaceable insert has a tendency to pinch inward, toward the blade and riving knife, since it is now connected only at the front and there is no support in the back. The solution to this is the insert's anti-pinch/lockdown system, which is made of two counter-bores and drilled through-holes in the bottom of the throat plate on both sides of the riving knife slot. Through these two counter-bores and holes are placed screws which screw into the replaceable insert from the bottom of the plate. Once the screws are fully screwed into the insert, since the insert is now locked down to the throat plate on either side, the pinching issue is resolved.

This aspect of anti-pinch design is made by means of various-sized drills and endmills upon manufacture in a CNC mill.

The Colli-BeckSS has two diagonally-placed set screws on the side of the plate for perfect snugging of the plate in both “X” and “Y” direction in the throat of the saw. One of the screws is placed in the back-right of the plate, pointing to “2 o'clock,” and the other in the front-right, pointing to “4 o'clock.”

Aside from the aforementioned unique qualities of the Colli-BeckSS, it has all the standard, necessary features that a throat plate must have in order to work with the SawStop table saw, i.e., all clearance ports on the bottom of the plate are made for clearance of all the below-the-table features (such as arbor nuts and bolts, safety features).

A finger hole is included for quick in/out access of the plate to/from the saw's throat.

1: The throat plate's replaceable-insert design has features that are new, unique and applicable to patent law. The unique features are characterized by the beveled clearance slots for the different riving knives and the beveled clearance port for the saw blade which have never previously been applied to a replaceable insert design. That the replaceable insert is characterized by the fact that it does not extend the full length of the throat plate and ends shortly before the front of the plate is a new and unique design.

2: The throat plate's anti-pinch/lockdown system for the replaceable insert is new, unique and applicable to patent law. This method of replaceable insert securement, characterized by the two anti-pinch screws fastening through the two counter-bores and through holes of the throat plate and into the replaceable insert from below, securing the replaceable insert in its place, has never before been applied to this application and is a vital aspect of the throat plate's functionality

3: The throat plate's T-slot housing and adjustment bores for the saw's back throat plate adjustment screws, which provides anti-flip back protection and above-the-plate height adjustment for the throat plate, is new, unique and applicable to patent law. This T-slot and adjustment screw coupling, with access to this coupling by means of the adjustment bore, has never been employed in this fashion and is essential to the functioning of this design.
